(19) United States
(12) Patent Application Publication
(10) Pub. No.: US 2002/0130025 A1
(43) Pub. Date: Sep. 19, 2002

(54) Vented flat panel switch

(76) Inventor: Peter Laier, Gilbert, AZ (US)

Correspondence Address: DURASWITCH, 234 S. EXTENSION, SEC. 103, MESA, AZ, 85210, US

(21) Appl. No.: 09/810,842

(22) Filed: Mar. 16, 2001

(51) Int. Cl. H01H 13/70

(52) U.S. Cl. 200/516

(57) ABSTRACT

An electrical switch laminate includes: a flexible membrane layer, a plurality of sub layers including a backing layer, electrical contacts of the switch within a switch cavity of the laminate, and an electrically conductive upper contact within the switch cavity of the laminate. The flexible membrane layer overlays and partially encloses the switch cavity that is airtight except for a vent passage extending along a major surface of one of the sub layers to equalize the pressure between the switch cavity and a surrounding environment.

### BACKGROUND OF THE INVENTION

The present invention relates to an electrical switch laminate with a switch cavity, containing an electrically conductive upper contact and electrical contacts of the switch, that is partially enclosed by a flexible membrane layer; and, in particular, to an electrical switch laminate wherein the switch cavity is airtight except for a vent extending along a major surface of a laminate sub layer to equalize the pressure between the switch cavity and a surrounding environment.

Flat panel membrane switches typically include a flexible membrane overlay and sub layers, including a backing layer. A switch cavity within the switch contains the electrically conductive upper contact and electrical contacts of the switch. Typically, the upper contact is moved into or out of engagement with at least one of the electrical contacts of the switch within the switch cavity by depressing the flexible membrane layer (a pushbutton switch), by sliding an actuator or knob over the flexible membrane layer (a slide switch), or by rotating an actuating knob overlaying the flexible membrane layer (a rotary switch). By way of example, U.S. Pat. No. 5,666,096, issued Sep. 9, 1997, discloses several flat panel switches. Any ballooning or depression of the portions of the flexible membrane layers that partially enclose the cavities within these switches might adversely affect the appearance or tactile feel of the switches. Accordingly, to enable these switches to operate in surrounding environments having decreased or increased pressures, without a ballooning or depression of the portions of the flexible membrane layers partially enclosing the switch cavities, the switch cavities are vented to a surrounding environment to equalize the pressure within the switch cavities and a surrounding environment. However, the venting of these switch cavities, to provide an equalization of pressure between the switch cavities and their surrounding environments, should be accomplished with a cost effective manufacturing procedure which forms a vent that inhibits or prevents the ingress of dust, dirt and/or liquids into the cavities of these switches.

### SUMMARY OF THE INVENTION

The provision of a vent, at low cost, to effect an equalization of pressure between the switch cavity of a flat panel switch and a surrounding environment and to inhibit or prevent the ingress of foreign matter into the switch cavity is provided by the flat panel switch of the present invention. The flat panel switch of the present invention includes: a flexible membrane layer, sub layers, electrical contacts within a switch cavity of the laminate, and an electrically conductive upper contact within the switch cavity. The flexible membrane layer overlays and partially encloses the switch cavity that is airtight except for a vent passage extending along a major surface of one of the sub layers to equalize the pressure between the switch cavity and a surrounding environment. A major surface is any surface in the plane of the flat panel switch having surface edges at both the switch cavity and a surrounding environment. The upper contact is moved into or out of engagement with at least one of the electrical contacts of the switch within the switch cavity by depressing the flexible membrane layer (a pushbutton switch), by sliding an actuator or knob over the flexible membrane layer (a slide switch), or by rotating an actuating knob overlaying the flexible membrane layer (a rotary switch). The electrodes of the flat panel switch of the present invention may be arranged to have spaced pads with the upper contact moving into or out of shorting relation with these pads; the electrodes may form a resistive element of a potentiometer with the upper contact providing a take-off element; or other electrode arrangements may be incorporated into the switch to provide a desired logic or output.

The vent passage of the present invention extends along a major surface of one of the sub layers from the switch cavity to an outer peripheral edge of the one sub layer. The one sub layer is that sub layer which is intentionally debossed, cut or otherwise deformed to allow for the vent passage. The vent can be formed along a major surface of the one sub layer in one process step without the need to cut out or otherwise remove any material from the one sub layer. In a first embodiment of the invention, the one sub layer is formed of a rigid or flexible material that separates when cut along a major surface, due to stresses within the material, to form a groove in the cut surface that extends from the switch cavity to an outer peripheral edge of the one sub layer. In a second embodiment of the invention, the one sub layer is formed of a rigid or flexible material that can be debossed to form and retain a groove along a major surface from the switch cavity to an outer peripheral edge of the one sub layer. In a third embodiment of the present invention, the one sub layer is formed of a resilient material and the vent passage is a tube, extending from the switch cavity to an outer peripheral edge of the one sub layer, that is pressed into and becomes fully or partially embedded in the one sub layer when the layers of the flat panel switch are laminated together to form the switch. In addition to the above, the vent passage may also be formed by placing a tube in a groove formed in accordance with the first or second embodiments of the invention. However, this procedure involves an additional process step.

To inhibit the ingress of dust, dirt and/or liquid into the switch cavity, the vent passage of the present invention, which extends between the switch cavity and a surrounding environment of the switch, has a small, transverse, cross sectional area. To further inhibit the ingress of dust, dirt and/or liquids into the switch cavity, the vent passage may be sinuous and/or include a filtration medium within the passage to trap dust, dirt and/or liquids.

### BRIEF DESCRIPTION OF THE DRAWINGS

FIG. 1 is a schematic plan view of one type of upper contact for a flat panel switch of the present invention.

FIG. 2 is a schematic section through a flat panel switch of the present invention utilizing the push button upper contact of FIG. 1.

FIG. 3 is a schematic section through a second flat panel switch of the present invention utilizing the push button upper contact of FIG. 1

FIG. 4 is an exploded perspective view of the flat panel switch of FIG. 2.

FIG. 5 is a schematic plan view the sub layers of the flat panel switches of FIGS. 2 to 4 with a sinuous vent passage.

FIG. 6 is a schematic transverse cross section, in a larger scale than FIGS. 1 to 5, of a vent passage groove with a generally triangular transverse cross section in the one sub layer of the flat panel switch of the present invention.

FIG. 7 is a transverse cross section of the vent passage groove of FIG. 6 with a filtration medium in the groove.

FIG. 8 is a schematic transverse cross section, in a larger scale than FIGS. 1 to 5, of a vent passage groove with a generally semicircular transverse cross section in the one sub layer of the flat panel switch of the present invention.

FIG. 9 is a transverse cross section of the vent passage groove of FIG. 8 with a filtration medium in the groove.

FIG. 10 is a schematic transverse cross section, in a larger scale than FIGS. 1 to 5, of a vent passage tube with a generally circular transverse cross section in the one sub layer of the flat panel switch of the present invention.

FIG. 11 is a transverse cross section of the vent passage tube of FIG. 10 with a filtration medium in the groove.

### DESCRIPTION OF THE PREFERRED EMBODIMENT

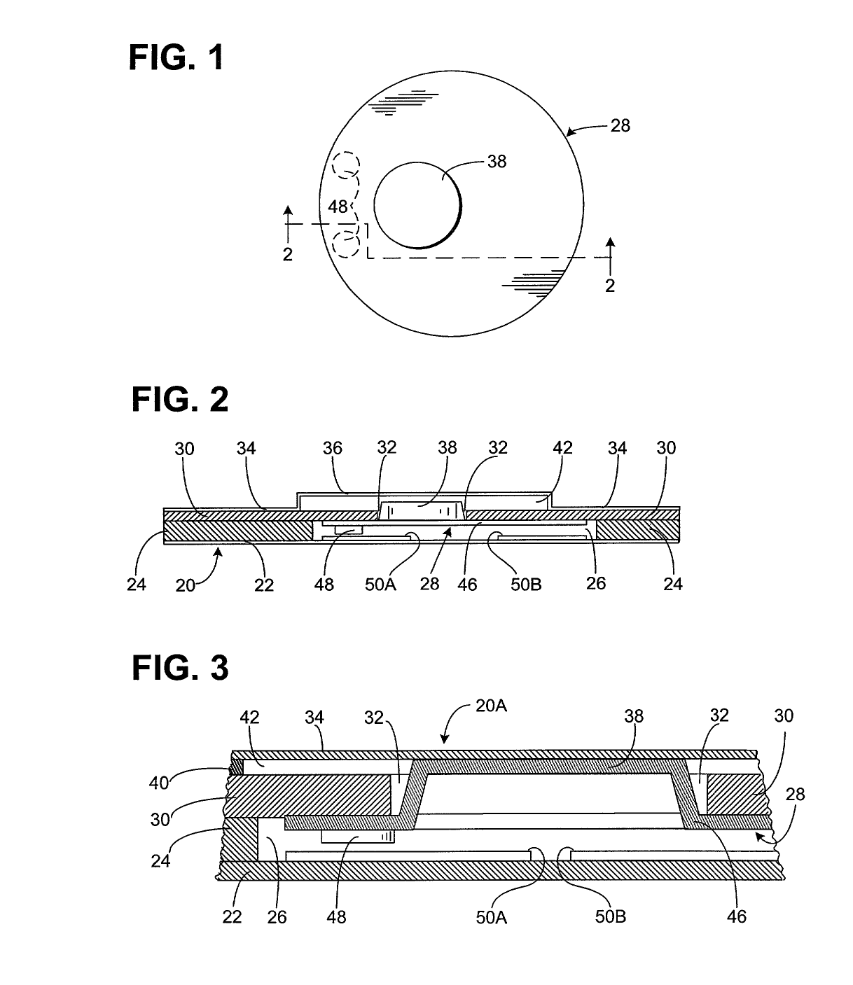

FIGS. 1,2 and 4 illustrate a first flat panel switch 20 vented in accordance with the present invention. The switch 20 is a laminate and, starting from the bottom up, the switch 20 includes: a backing layer 22; a spacing layer 24 with an opening 26 therein; an upper contact 28; a magnetic coupling layer 30 with an opening 32 therein; and a flexible membrane layer 34. The sub layers usually include: a backing layer 22, a spacing layer 24, a magnetic coupling layer 30, and sometimes a filler layer (shown in FIG. 3 at 40). The flexible membrane layer 34 and the sub layers are bonded or otherwise secured together to form the flat panel switch laminate.

The flexible membrane layer 34 is typically made from a thin flexible, liquid and air impermeable, polymeric film, e.g. a polyester film about 5 mils to about 8 mils thick, and may be embossed as shown at 36 to provide a space for the actuating button 38 of the upper contact to project upward above the magnetic coupling layer 30. FIG. 3 illustrates a second flat panel switch 20A, with an alternative structure, vented in accordance with the present invention. The flat panel switch 20A includes a filler layer 40, with an opening 42 therein, intermediate the magnetic coupling layer 30 and the flexible membrane layer 34. With this structure, the thin, flexible membrane layer 34 may be a polymeric film that does not have to be embossed to provide a space for the actuating button 38 of the upper contact to project upward above the magnetic layer 30. Other than the inclusion of the filler layer 40 and the elimination of the embossment 36 in the flexible membrane layer 34, the switch 20A of FIG. 3 is the same as the switch of FIGS. 1, 2 and 4.

While flat panel switches 20 and 20A are representative of the switches that may be vented in accordance with the present invention, it is to be understood that other flat panel switches with otherwise air tight cavities, containing an electrically conductive upper contact, electrical contacts of the switch and a flexible membrane layer that partially encloses the switch cavity, may also be vented in accordance with the present invention. For example, the upper contact of a flat panel switch vented in accordance with the present invention may be moved into or out of engagement with at least one of the electrical contacts of the switch within the switch cavity by depressing the flexible membrane layer (a pushbutton switch), by sliding an actuator or knob over the flexible membrane layer (a slide switch), or by rotating an actuating knob overlaying the flexible membrane layer (a rotary switch). In addition, the electrodes of a flat panel switch vented in accordance with the present invention may be arranged to have spaced pads with the upper contact moving into or out of shorting relation with these pads; the electrodes may form a resistive element of a potentiometer with the upper contact providing a take-off element; or other electrode arrangements may be incorporated into the switch to provide a desired logic or output.

The flat panel switch 20 or 20A has a switch cavity therein with sidewalls defined by the openings 26 and 32 in spacing layer 24 and magnetic coupling layer 30 or the openings 26, 32 and 42 in the spacing layer 24, the magnetic coupling layer 30 and the filler layer 40. The backing layer 22 encloses one end of the switch cavity while the flexible membrane layer 34 encloses the other end of the switch cavity.

The upper contact 28 is electrically conductive and is located within the switch cavity with a contact portion 46 intermediate the underside of the magnetic coupling layer 30 and the backing layer 22, and the actuating button 38 projecting up through the opening 32 in the magnetic coupling layer 30. While, for the application shown, the contact portion 46 of the upper contact 28 is provided with a pair of buttons 48 about which the upper contact 28 pivots when the actuating button 38 is depressed, for other applications these buttons may be omitted. The upper contact 28 and the magnetic coupling layer 30 are both made of magnetic material with at least one of these components being a permanent magnet. As used herein the term “magnetic material” means a material affected by a magnet. Where the magnetic coupling layer 30 is a permanent magnet, the upper contact may be made of steel or similar electrically conductive magnetic materials. Depending on the application, the magnetic coupling layer 30 may be rigid or flexible.

The spacing layer 24 and filler layer 40 are made of an electrically nonconductive material and, depending on the application, may be rigid or flexible. Preferably, the spacing layer 24 and filler layer 40 are made from a material: that separates when cut along a major surface, due to stresses within the material, to form a groove in a major surface of the one sub layer, such as but not limited to foam; that can be readily debossed or deformed to form a groove in a major surface of the one sub layer, such as, but not limited to foam; or that is resilient and can be readily deformed to partially or wholly embed a tube in a major surface of the one sub layer, such as but not limited to foam. An example of a spacing layer material that separates when cut along a major surface to form a groove in a major surface of the one sub layer is foam sold by Voltech under the trade designation Volara. An example of a deformable spacing layer material that retains or substantially retains its deformed shape and can be readily debossed along a major surface to form a groove in a major surface of the one sub layer is foam sold by 3M under the trade designation VHB. An example of a resilient spacing layer material that can be readily deformed along a major surface to partially or wholly embed a tube in a major surface of the one sub layer is foam sold by 3M under the trade designation VHB.

The backing layer 22 of the switch 20 is electrically non-conductive and may be rigid or flexible as required for a particular application. Depending on the application for which, or environment in which, the switch 20 is to be used, the backing layer 22 may be made of a variety of materials, such as but not limited to polyester film, circuit boards and dielectric-coated thin steel sheets. The backing layer 22 has electrodes 50A and 50B on the portion of its inner surface that closes one end of the switch cavity. The electrodes 50A and 50B may be formed on the backing layer by screen-printing, etching or other suitable processes.

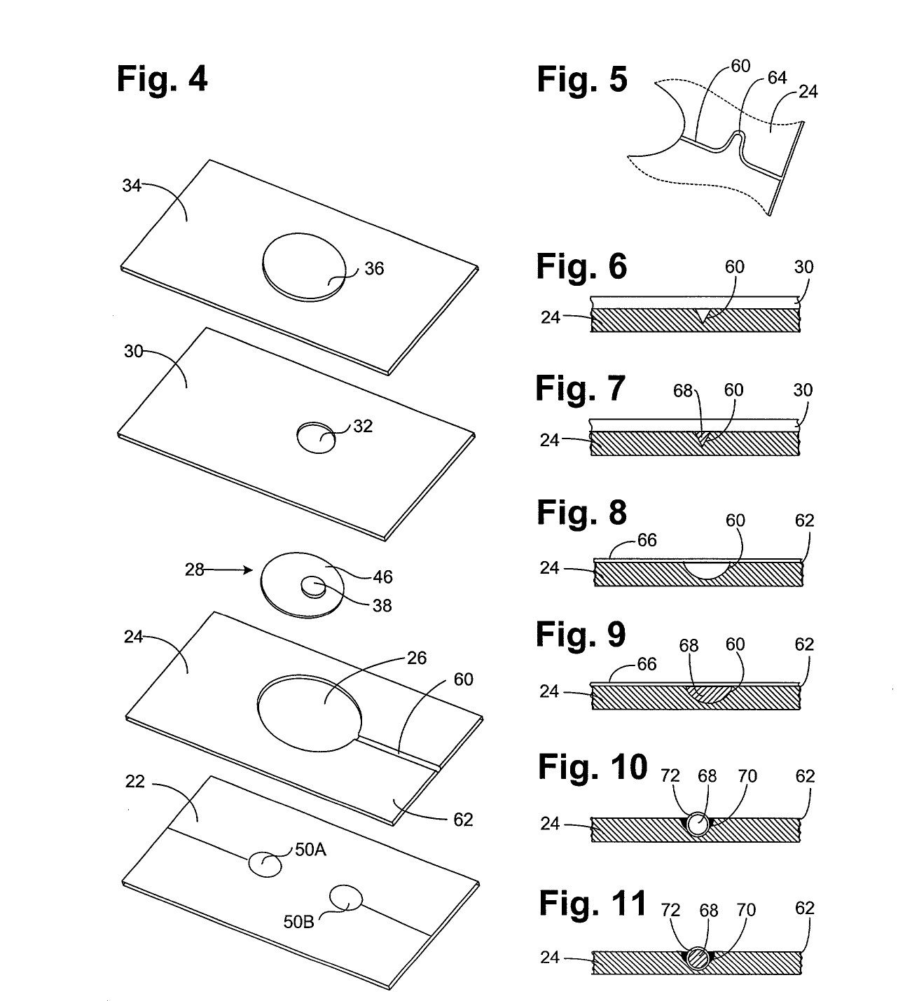

As best shown in FIG. 4, the vent passage 60 of the present invention extends from the switch cavity to an external edge of the switch 20 or 20A, preferably along one of the major surfaces of the spacing layer 24 or filler layer 40. The vent passage thereby connects the switch cavity to a surrounding environment. While it is preferred to form the vent passage in the spacing layer 24 or filler layer 40, provided that sub layer is made of one of the materials disclosed above in connection with the spacing layer 24 and filler layer 40, the vent passage 60 may be formed from the switch cavity to an external edge of the switch along a major surface of the magnetic coupler layer 30, or along another sub layer of the switch located intermediate the flexible membrane layer 34 and the backing layer 22. While the vent passage 60 is typically straight as shown in FIG. 4, the vent passage may also be sinuous with one or more curves or bends 64 intermediate the inner and outer ends of the vent passage 60, such as shown in FIG. 5. The curve(s) or bend(s) 64 in the vent passage 60 acts as a trap to further inhibit the ingress of dust, dirt and/or liquids into the switch cavity.

FIGS. 6 and 7 show a vent passage 60 that has been formed in the spacing layer 24 or in one of the other sub layers of the switch 20 or 20A. The vent passage 60 has a generally triangular transverse cross section with a generally V-shaped groove in a major surface of the one sub layer. This V-shaped groove may be enclosed by an adjacent layer of the assembled switch, e.g. magnetic coupling layer 30, to complete the formation of the vent passage 60. The vent passage 60, thus formed, may be straight or sinuous to further inhibit the ingress of dust, dirt and/or liquids into the switch cavity and, as shown in FIG. 7, may include a filtration medium 68. The filtration medium 68 may be any porous material that will both trap dirt, dust and/or liquids and be permeable to air, such as but not limited to a porous string or yarn or other fibrous material, so that the passage of dirt, dust and/or liquids into the switch cavity is further inhibited.

Where the one sub layer is made of a material that separates, upon being cut along a major surface, due to stresses within the material, the generally V-shaped groove may be formed in a major surface of the one sub layer with the material that separates by cutting a slit with a die or other cutting tool. The slit passes part of the way through the thickness of the grooved one sub layer and extends along the desired path of the vent passage from the switch cavity to an outer peripheral edge of the one sub layer. Once the slit is formed in a major surface of the grooved one sub layer, the slit opens up into a generally V-shaped configuration to form the vent passage due to the stresses present in the material. Where the one sub layer is made of a material that can be readily debossed or deformed to form a groove, the generally V-shaped groove may be formed in a major surface from the switch cavity to an outer peripheral edge of the one sub layer by compressing the desired one sub layer along the path of the vent passage with a steel rule die creasing rule or other deforming tool shaped to form a groove with a generally V-shaped cross section.

FIGS. 8 and 9 show a vent passage 60 that has been formed in one of the major surfaces 62 of the spacing layer 24 or in one of the other sub layers of the switch 20 or 20A. The vent passage 60 has a generally semicircular transverse cross section with a generally U-shaped groove in a major surface of the spacing layer. This U-shaped groove may be enclosed by an overlay 66 of sheet material, such as a polymeric film, or some other material that is bonded or otherwise secured to a major surface of the one sub layer to complete the formation of the vent passage 60 or an adjacent layer of the assembled switch, e.g. flexible membrane layer 34, magnetic coupling layer 30, spacing layer 24 or filler layer 40, or backing layer 22, may enclose the groove to form the passage. The vent passage 60, thus formed, may be straight or sinuous to further inhibit the ingress of dust, dirt and/or liquids into the switch cavity 44 and, as shown in FIG. 9, may include a filtration medium 68. The filtration medium 68 may be any porous material that will both trap dirt, dust and/or liquids and be permeable to air, such as but not limited to a porous string or yarn or other fibrous material, so that the passage of dirt, dust and/or liquids into the switch cavity is further inhibited. The one sub layer is made of a material that can be readily debossed or deformed to form a groove and the generally U-shaped groove is formed from the switch cavity to an outer peripheral edge of the one sub layer by compressing the venting sub layer along the desired path of the vent passage with a steel rule die creasing rule or other deforming tool shaped to form a groove with a generally U-shaped cross section.

FIGS. 10 and 11 show a vent passage 60 that has been formed along major surface 62 of the spacing layer 24 or in one of the other sub layers of the switch 20 or 20A. The vent passage 60 is formed by a tube 70, e.g. 32 gauge wire sheathing, and while, as shown, the tube has a generally circular transverse cross section, the tube 70 may have generally oval, flat oval or other transverse cross sectional configurations. As shown, the tube 70 is partially embedded in and adhesively bonded to a major surface 62 of the one sub layer with an adhesive 72. However, the tube may be partially or completely embedded within the one sub layer and an overlaying layer of the switch laminate, e.g. magnetic coupling layer 30, may be used to hold the tube in place. The vent passage 60, thus formed with the tube 70, may be straight or sinuous to further inhibit the ingress of dust, dirt and/or liquids into the switch cavity and, as shown in FIG. 11, may include a filtration medium 68. The filtration medium 68 may be any porous material that will both trap dirt, dust and/or liquids and be permeable to air, such as but not limited to a porous string or yarn or other fibrous material, so that the passage of dirt, dust and/or liquids into the switch cavity is further inhibited.

With the embodiment of FIGS. 10 and 11, the tube 70 may be placed in a groove formed in the one sub layer by cutting the one sub layer along a major surface as described in connection with FIGS. 6 and 7 or by placing the tube 70 in a groove formed in the one sub layer by debossing or deforming the one sub layer along a major surface as described in connection with FIGS. 8 and 9. However, where the one sub layer is made of a resilient material, the tube 70 may be pressed into and partially or totally embedded in a major surface of the one sub layer along a desired path for the vent passage 60 by merely pressing the tube 70 into a major surface of the one sub layer with an overlaying layer of the switch when the layers of the switch are pressed and bonded or otherwise secured together to form the laminated switch. For example, where the vent passage 60 is to extend along the upper major surface 62 of the spacing layer 24, the underside of the magnetic coupling layer 30 will press the tube 70 into a major surface of the resilient spacing layer 24 to partially or totally embed the tube in the spacing layer 24. While an adhesive may be used to help hold the tube in place, e.g. while the switch is being assembled, the use of an adhesive is not required.

With the vent passage 60 connecting the switch cavity to a surrounding environment, air and/or any other gas present passes between the switch cavity and a surrounding environment and the pressure between the switch cavity and surrounding environment is continuously equalized to maintain the flat panel switch in good working order and to keep the flexible membrane layer 34 of the switch from ballooning or being depressed. The interface between the upper contact 28 and the magnetic coupling layer 30 or other sub layer permits air and/or any other gas to pass between the lower and the upper side of the coupling layer so that, wherever the vent enters the switch cavity, the entire switch cavity is fully vented to a surrounding environment.

The surrounding environment referred to throughout this patent may be the atmosphere, or it may be another cavity. If the surrounding environment is another switch cavity, the pressure in switch cavities connected by a vent will equalize. The number of switches that may be vented together using the vent of the present invention is not limited. A keyboard or panel with numerous switches may all be vented to each other, and also vented to the external environment by having at least one of the switch cavities vented to the external environment. The benefit of using the vent of the present invention is that all sub layers of the multi-switch panel are single piece layers. If switch vents on a switch panel were made by cutting through and removing parts of the one sub layer, the one sub layer would tend to fall apart and may be difficult to align with other sub layers of the switch panel. A further surrounding environment may be a bladder that will suitably allow the switch cavities to equalize with their external environment. Such a bladder would connect to the edge of the one sub layer where the vent passage ends.

While the operation of flat panel switches such as flat panel switches 20 and 20A is probably apparent, the operation of these switches will be briefly discussed. To actuate the pushbutton flat panel switch 20 or 20A, the user presses the actuating button 38 of the upper contact. As the user presses the flexible membrane layer 34, pre-travel is achieved and the flexible membrane layer is first deformed. As the flexible membrane layer is further deformed, the upper contact 28 abruptly breaks away from the magnetic coupling layer 30 thereby providing a very crisp tactile sensation. In the switches shown, the portion of the upper contact 28 with the fulcrum buttons 48 will snap loose from the magnetic coupling layer 30 and engage the electrode 50A. Thereafter, the upper contact 28 will pivot about the buttons 48 which function as a fulcrum, and into contact with electrode 50B. This shorts the electrodes 50A and 50B, which are connected to suitable external circuitry (not shown), and closes the switch. Upon the release of the closing pressure, the magnetic attraction between the magnetic coupling layer 30 and the upper contact 28 returns the upper contact to its initial position thereby reopening the switch. As mentioned above, it is to be understood that flat panel switches 20 and 20A are merely representative of the flat panel switches that may be vented in accordance with the present invention and that other flat panel switches may be vented in accordance with the present invention. For example, the flat panel switches vented in accordance with the present invention could be potentiometers or could include other upper contact and electrode arrangements.

In describing the invention, certain embodiments have been used to illustrate the invention and the practice thereof. However, the invention is not limited to these specific embodiments as other embodiments and modifications within the spirit of the invention will readily occur to those skilled in the art on reading this specification. Thus, the invention is not intended to be limited to the specific embodiments disclosed, but is to be limited only by the claims appended hereto.

What is claimed is:

1. An electrical switch laminate, comprising:
a flexible membrane layer;
a plurality of sub layers including a backing layer;
a switch cavity within the electrical switch laminate;
a portion of the flexible membrane layer overlaying and partially enclosing the switch cavity; the portion of the flexible membrane layer overlaying and partially enclosing the switch cavity having an outer surface exposed to a surrounding environment;
an electrically conductive upper contact within the switch cavity;
electrical contacts of the switch within the switch cavity; and
the switch cavity being airtight except for a vent passage, extending along a major surface of one of the sub layers from the switch cavity to a peripheral edge of the switch to equalize pressure between the switch cavity and a surrounding environment, formed without removing material from the one sub layer.

2. The electrical switch according to claim 1, wherein:
an air permeable filtration medium is within the vent passage to prevent foreign particles from passing into the switch cavity through the vent passage and inhibit the passage of liquid into the switch cavity through the vent passage.

3. The electrical switch according to claim 1, wherein:
the vent passage is sinuous.

4. The electrical switch according to claim 3, wherein:
an air permeable filtration medium is within the vent passage to prevent foreign particles from passing into the switch cavity through the vent passage and inhibit the passage of liquid into the switch cavity through the vent passage.

5. The electrical switch according to claim 1, wherein:
the one sub layer comprises a deformable material which retains or substantially retains a deformed shape when the one sub layer is debossed; and the vent passage comprises a groove, extending from the switch cavity to an outer peripheral edge of the one sub layer, formed in a major surface of the one sub layer by debossing the material of the one sub layer.

6. The electrical switch according to claim 5, wherein:
an air permeable filtration medium is within the groove to prevent foreign particles from passing into the switch cavity through the groove and inhibit the passage of liquid into the switch cavity through the groove.

7. The electrical switch according to claim 5, wherein:
the groove is sinuous.

8. The electrical switch according to claim 7, wherein:
an air permeable filtration medium is within the groove to prevent foreign particles from passing into the switch cavity through the groove and inhibit the passage of liquid into the switch cavity through the groove.

9. The electrical switch according to claim 1, wherein:
the one sub layer comprises a material which when slit, part of the way through the one sub layer along a major surface, spreads apart to form a groove; and the vent passage comprises a groove, extending from the switch cavity to an outer peripheral edge of the one sub layer, formed by slitting the one sub layer part of the way through the one sub layer along a major surface of the one sub layer.

10. The electrical switch according to claim 9, wherein:
an air permeable filtration medium is within the groove to prevent foreign particles from passing into the switch cavity through the groove and inhibit the passage of liquid into the switch cavity through the groove.

11. The electrical switch according to claim 9, wherein:
the groove is sinuous.

12. The electrical switch according to claim 11, wherein:
an air permeable filtration medium is within the groove to prevent foreign particles from passing into the switch cavity through the groove and inhibit the passage of liquid into the switch cavity through the groove.

13. The electrical switch according to claim 1, wherein:
the vent is a tube at least partially embedded in a major surface of the one sub layer and extending from the switch cavity to the outer periphery of the one sub layer.

15. The electrical switch according to claim 13, wherein:
the tube forms a sinuous vent passage.

16. The electrical switch according to claim 15, wherein:
an air permeable filtration medium is within the tube to prevent foreign particles from passing into the switch cavity through the tube and inhibit the passage of liquid into the switch cavity through the tube.

17. The electrical switch according to claim 1, wherein:
the electrically conductive upper contact comprises a magnetic material; the electrical switch includes magnetic means for normally maintaining the electrically conductive upper contact in or out of engagement with one of the electrical contacts of the switch; and the flexible membrane layer overlays an actuating portion of the electrically conductive upper contact and depression of the flexible membrane layer moves the electrically conductive upper contact relative to one of the electrical contacts of the switch.

18. The electrical switch according to claim 1, wherein:
the surrounding environment is a bladder.

19. The electrical switch according to claim 1, wherein:
the surrounding environment is a second cavity in communication with the atmosphere.

20. An improved method of making a vented electrical switch laminate, comprising:
joining a flexible membrane layer and a plurality of sub layers including a backing layer together to form a switch laminate having a switch cavity with an electrically conductive upper contact and electrical contacts of the switch therein wherein a portion of the flexible membrane layer having an outer surface exposed to a surrounding environment overlays and partially encloses the switch cavity and the switch cavity is airtight except for a vent passage extending along a major surface of one of the sub layers from the switch cavity to a peripheral edge of the switch to equalize pressure between the switch cavity and a surrounding environment; and
forming the vent passage along a major surface of the one sub layer without removing any material from the one sub layer.

21. The method of making a vented electrical switch according to claim 20, including:
placing an air permeable filtration medium within the vent passage to prevent foreign particles from passing into the switch cavity through the vent passage and inhibit the passage of liquid into the switch cavity through the vent passage.

22. The method of making a vented electrical switch according to claim 20, wherein:
the vent passage formed is sinuous.

23. The method of making a vented electrical switch according to claim 22, including:
placing an air permeable filtration medium within the vent passage to prevent foreign particles from passing into the switch cavity through the vent passage and inhibit the passage of liquid into the switch cavity through the vent passage.

24. The method of making a vented electrical switch according to claim 20, wherein:
the one sub layer comprises a deformable material which retains or substantially retains a deformed shape when the one sub layer is debossed; and the vent passage comprises a groove, extending from the switch cavity to an outer peripheral edge of the one sub layer, which is formed in a major surface of the one sub layer by debossing the material of the one sub layer.

25. The method of making a vented electrical switch according to claim 24, including:
placing an air permeable filtration medium within the groove to prevent foreign particles from passing into the switch cavity through the groove and inhibit the passage of liquid into the switch cavity through the groove.

26. The method of making a vented electrical switch according to claim 24, wherein:
the groove formed is sinuous.

27. The method of making a vented electrical switch according to claim 26, including:
placing an air permeable filtration medium within the groove to prevent foreign particles from passing into the switch cavity through the groove and inhibit the passage of liquid into the switch cavity through the groove.

28. The method of making a vented electrical switch according to claim 20, wherein:
the one sub layer comprises a material which when slit, part of the way through the one sub layer along a major surface, spreads apart to form a groove; and the vent passage comprises a groove, extending from the switch cavity to an outer peripheral edge of the one sub layer, formed by slitting the one sub layer part of the way through the one sub layer along a major surface of the one sub layer.

29. The method of making a vented electrical switch according to claim 28, including:
placing an air permeable filtration medium within the groove to prevent foreign particles from passing into the switch cavity through the groove and inhibit the passage of liquid into the switch cavity through the groove.

30. The method of making a vented electrical switch according to claim 28, wherein:
the groove formed is sinuous.

31. The method of making a vented electrical switch according to claim 30, including:
placing an air permeable filtration medium within the groove to prevent foreign particles from passing into the switch cavity through the groove and inhibit the passage of liquid into the switch cavity through the groove.

32. The method of making a vented electrical switch according to claim 20, wherein:
the vent passage is formed by at least partially embedding a tube in a major surface of the one sub layer.

33. The method of making a vented electrical switch according to claim 32, including:
placing an air permeable filtration medium within the tube to prevent foreign particles from passing into the switch cavity through the tube and inhibit the passage of liquid into the switch cavity through the tube.

34. The method of making a vented electrical switch according to claim 32, wherein:
the tube is at least partially embedded in a major surface of the one sub layer to form a sinuous vent passage.

35. The method of making a vented electrical switch according to claim 34, including:
placing an air permeable filtration medium within the tube to prevent foreign particles from passing into the switch cavity through the tube and inhibit the passage of water into the switch cavity through the tube.

36. The method of making a vented electrical switch according to claim 20, wherein:
the one sub layer is intermediate the backing layer and the flexible membrane layer.
